(19) United States
(12) Patent Application Publication
(10) Pub. No.: US 2006/0034254 A1
(43) Pub. Date: Feb. 16, 2006

(54) System and method for managing HTTP connections in a J2EE environment

(76) Inventors: William R. Trost, Mequon, WI (US); Scott Alan Beckwith, East Troy, WI (US); Thomas A. Mills, Dousman, WI (US); James R. Chadek, Dousman, WI (US)

Correspondence Address: TOLER & LARSON & ABEL L.L.P., 5000 PLAZA ON THE LAKE STE 265, AUSTIN, TX, 78746, US

(21) Appl. No.: 10/916,372

(22) Filed: Aug. 11, 2004

(51) Int. Cl. H04L 12/66

(52) U.S. Cl. 370/352

(57) ABSTRACT

A network system is provided and includes an enterprise information system. A web application server communicates with the enterprise information system and an application component communicates with the web application server. A connection manager resides in the web application server and manages a plurality of connection handles. Each one of the plurality of connection handles corresponds to one or more physical connections to the enterprise information system via hypertext transfer protocol (HTTP). Additionally, a Java 2 Platform, Enterprise Edition (J2EE) HTTP connector resides within the web application server in the form of a resource adapter and is responsive to the connection manager.

### FIELD OF THE DISCLOSURE

The present disclosure relates generally to network management systems.

### BACKGROUND

Modem telecommunication companies currently provide numerous services and features that can be purchased in addition to traditional services such as local calling and long-distance calling. For example, custom calling features can include: caller identification, call waiting, three-way calling, call forwarding, remote call forwarding, automatic call back, repeat dialing, speed dialing, call rejection, and call hunting. Moreover, with the explosion of the Internet, telephone service providers now also provide high-speed Internet services, e.g., digital subscriber line (DSL) service. These services can be purchased individually or in bundles.

Websites have been provided to allow users to modify their telephone accounts. For example, if a user would like to add call blocking or call rejection to their account, he or she can access their account information using a web browser and request that call blocking be added to their account. An application component running in the background can contact an enterprise information system (EIS), for example, and indicate that the user wants to change his or her account. In certain instances, the “conversation” between the user and the application component or EIS is made using hypertext transfer protocol (HTTP).

It appears that many telecommunication companies may utilize the Java 2 Platform, Enterprise Edition (J2EE), introduced in 1998, to fulfill their networking needs. J2EE defines a multi-tier architecture for enterprise information systems (EIS). By defining the way in which multi-tier applications should be developed, J2EE reduces the costs, in both time and money, of developing large-scale enterprise systems. However, the J2EE platform does not describe a system or method to manage HTTP connections.

Accordingly, there is a need for a system and method of managing HTTP connections that can work in conjunction with J2EE.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram of an embodiment of a data network system; and

FIG. 2 is a flow chart to illustrate the logic of a J2EE HTTP connector.

### DETAILED DESCRIPTION OF THE DRAWINGS

A network system is provided and includes an enterprise information system. A web application server communicates with the enterprise information system and an application component communicates with the web application server. A connection manager resides in the web application server and manages a plurality of connection handles. Each one of the plurality of connection handles corresponds to one or more physical connections to the enterprise information system via hypertext transfer protocol (HTTP). Additionally, a Java 2 Platform, Enterprise Edition (J2EE) HTTP connector resides within the web application server in the form of a resource adapter and is responsive to the connection manager.

In another embodiment, a J2EE web application server is provided and includes a connection manager. An HTTP connector communicates with the connection manager and returns at least one connection handle to the connection manager. In a particular embodiment, the connection handle corresponds to a physical connection to an enterprise information system using HTTP.

In yet another embodiment, a method for obtaining an HTTP connection to an enterprise information system in a J2EE environment is provided. The method includes receiving a request for an HTTP connection to an enterprise information system. The availability of a physical connection to the enterprise information system via HTTP is detected. A connection handle that corresponds to a physical connection to the enterprise information system is transmitted.

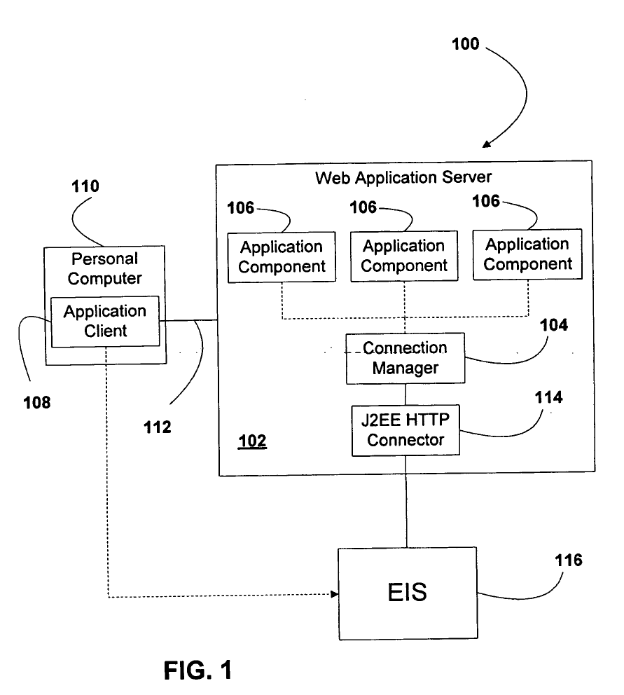

Referring initially to FIG. 1, a network system is illustrated and is generally designated 100. As illustrated in FIG. 1, the system 100 includes a web application server 102. In a particular embodiment, the web application server 102 can be any Java 2 Platform, Enterprise Edition (J2EE) compliant web application server such as an IBM WebSphere server or a BEA WebLogic server. FIG. 1 depicts a connection manager 104 that resides within the web application server 102. Further, a plurality of internal application components 106 resides within the web application server 102. While three internal application components 106 are illustrated, more than three application components 106 may reside within the web application server 102. FIG. 1 further shows an external application component, such as an application client 108, that resides external to the web application server 102. As depicted in FIG. 1, the external application client 108 can reside in a computer 110, e.g., a personal computer, that communicates with the web application server 102 via a network connection 112, e.g., the Internet. For clarity, one external application client 108 is shown, but more than one external application client 108 can be provided and each external application client 108 communicate with the application server 102 via the network connection 112.

FIG. 1 further shows a J2EE Hypertext Transfer Protocol (HTTP) connector 114 that also resides within the web application server 102. In a particular embodiment, the J2EE HTTP connector 114 is connected to, or otherwise interfaced with, the connection manager 104. The J2EE HTTP connector 114 also communicates with an enterprise information system (EIS) 116. A typical EIS can be used to manage and maintain large amounts of information, e.g., customer account information. During operation, one or more of the application components 106, 108 can request an HTTP connection to the EIS 116 from the connection manager 104. The connection manager 104 can provide a connection handle directly to the requesting application component 106, 108 or instruct the J2EE HTTP connector 114 to obtain the connection handle for the requesting application component 106, 108. The connection handle corresponds to a physical connection. Specifically, the connection handle encapsulates the access to the physical connection.

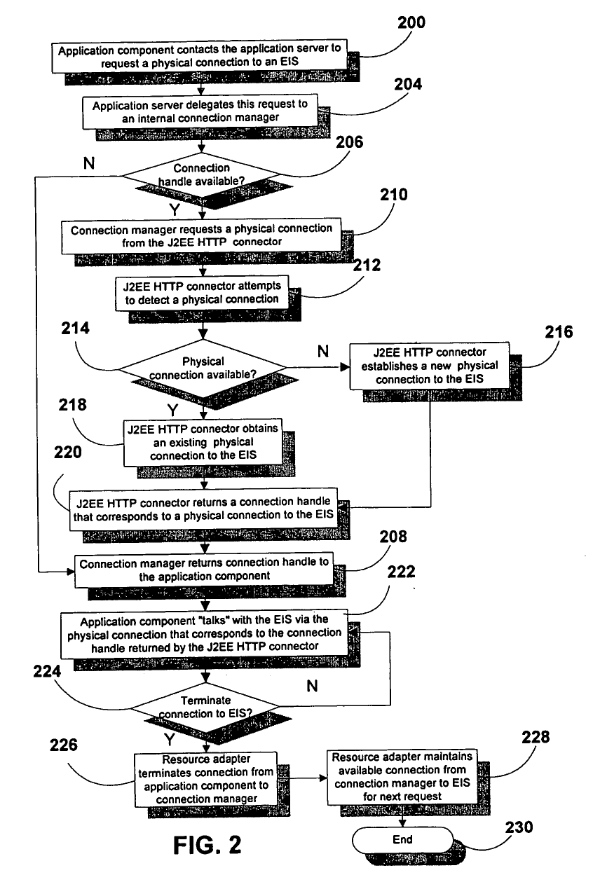

Referring now to FIG. 2, a flow chart is depicted that shows operating logic to provide access to the EIS 116 (FIG. 1) using HTTP. Beginning at block 202, an application component 106, 108 (FIG. 1) contacts the application server 102 (FIG. 1) in order to request a connection to the EIS 116 (FIG. 1). At block 204, the application server 102 (FIG. 1) delegates the request to an internal connection manager 104 (FIG. 1). Moving to decision step 206, the connection manager 104 (FIG. 1) determines whether a connection handle is available in its pool of connection handles. In an illustrative embodiment, a connection handle is a pointer that indicates where the physical connection exists and how the physical connection can be accessed. If a connection handle is available, the logic moves to block 208 and the connection manager 104 (FIG. 1) returns the connection handle to the application component 106, 108 (FIG. 1).

If a connection handle is not available at decision step 206, the logic proceeds to block 210 and the connection manager requests a connection handle from the J2EE HTTP connector 114 (FIG. 1). Moving to block 212, the J2EE HTTP connector 114 (FIG. 1) attempts to detect a physical connection 212 to the EIS 116 (FIG. 1). At decision step 214, the J2EE HTTP connector 114 (FIG. 1) determines if a physical connection to the EIS 116 (FIG. 1) is available. If a physical connection is not available, the J2EE HTTP connector 114 (FIG. 1) establishes a new physical connection with the EIS 116 (FIG. 1). Conversely, if a physical connection is available, the J2EE HTTP connector 114 (FIG. 1) obtains an existing physical connection to the EIS 116 (FIG. 1). At block 220, the J2EE HTTP connector 114 (FIG. 1) returns a connection handle to the connection manager 204. The connection handle corresponds to a physical connection to the EIS 116 (FIG. 1) established via HTTP. In a particular embodiment, block 220 is also reached from block 216 after a new physical connection to the EIS 116 (FIG. 1) is established.

Continuing to block 208, the connection manager 104 (FIG. 1) returns the connection handle to requesting the application component 106, 108 (FIG. 1). Thereafter, at block 222, the application component 106, 108 communicates with the EIS 116 (FIG. 1) via the connection handle returned by the J2EE HTTP connector 114 (FIG. 1). In a particular embodiment, the application component 106, 108 can communicate with the EIS 116 (FIG. 1) using HTTP. Proceeding to decision step 224, the web application server 102 (FIG. 1) determines whether the application component 106, 108 (FIG. 1) would like to terminate the communication with the EIS 116 (FIG. 1) and close the connection handle. If the application component 106, 108 (FIG. 1) does not want to close the connection handle, the logic returns to block 222 and the application component 106, 108 (FIG. 1) continues to communicate with the EIS 116 (FIG. 1). Otherwise, the logic proceeds to block 226 and the connection handle is returned to the pool of connection handles held by the connection. At block 228, the connection manager 104 maintains the connection handle for later use when a connection handle is again requested by an application component 106, 108 (FIG. 1).

In a particular embodiment, all connection requests are made at the application server 102 (FIG. 1). However, once an application component 106 (FIG. 1) has a connection handle, the communication with the EIS 116 (FIG. 1) can bypass the application server 102 (FIG. 1).

The present embodiment provides a java resource adapter than can be plugged into a J2EE compliant web application server to manage physical connections to an EIS. The J2EE HTTP connector can obtain a physical connection to an EIS using HTTP and then provide a corresponding connection handle to an application component in order to allow the application component to “talk,” i.e., communicate, to the EIS using HTTP. In an alternative embodiment, the J2EE HTTP connector can be expanded to also provide a connection to an EIS using the simple object access protocol (SOAP) transmission protocol.

In an illustrative embodiment, the J2EE HTTP connector can be used to manage all HTTP connections to a Service Management System (SMS). An SMS is a database server that can centralize management of critical service and subscriber data. The SMS can provide plural operations support functions and includes a feature for migrating subscriber data from an older service version to a new service version. Also, the SMS can include a data collection function for accumulating and reporting service-level and subscriber-level measurements gathered by a network element. The SMS can further provide an audit feature, which can be used as a troubleshooting tool for detecting discrepancies between the SMS and the network element versions of recently changed data.

Another function that the SMS can provide is bulk provisioning. In other words, the SMS provide the capability to provision bulk data whenever a customer's service provisioning requires such input rather than a single entry at a time from a graphical user interface (GUI). Moreover, the SMS can provide the ability to perform network element queries and simulated test queries. Finally, the SMS can provide re-homing, which is useful for relocating a subscriber's records from a previous network element to a new network element if the previous network has been outgrown. The re-homing feature can be used to restore network elements after recovery from a failure. An example of an SMS is the Enhanced Service Manager (eSM) that is offered commercially by Lucent Technologies.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An network system, comprising:
at least one enterprise information system;
at least one web application server communicating with the enterprise information system;
at least one application component communicating with the web application server;
at least one connection manager residing in the at least one web application server and managing a plurality of connection handles, each one of the plurality of connection handles corresponding to one or more physical connections to the enterprise information system via hypertext transfer protocol (HTTP); and
a Java 2 Platform, Enterprise Edition (J2EE) HTTP connector residing within the web application server and responsive to the at least one connection manager.

2. The system of claim 1, wherein the J2EE HTTP connector returns at least one of the plurality of connection handles to the at least one connection manager.

3. The system of claim 1, wherein the at least one connection manager returns at least one the plurality of connection handles to the application component.

4. The system of claim 3, wherein the J2EE HTTP connector receives a request for a connection handle from the connection manager.

5. The system of claim 3, wherein the J2EE HTTP connector determines if a physical connection to the enterprise information system is available via HTTP.

6. The system of claim 5, wherein the J2EE HTTP connector obtains an existing physical connection to the enterprise information system and returns at least one connection handle corresponding to the physical connection to the connection manager.

7. The system of claim 6, wherein the J2EE HTTP connector establishes a new physical connection to the enterprise information system and returns at least one connection handle corresponding to the physical connection to the connection manager.

8. A J2EE web application server, the web application server comprising:
a connection manager; and
an HTTP connector communicating with the connection manager, wherein the HTTP connector returns at least one connection handle to the connection manager, the at least one connection handle corresponding to a physical connection to an enterprise information system using HTTP.

9. The server of claim 8, wherein the HTTP connector is J2EE compliant.

10. The server of claim 9, wherein the HTTP connector comprises:
instructions to receive at least one request for a connection handle from the connection manager.

11. The server of claim 10, wherein the HTTP connector comprises:
instructions to determine if a physical connection to an enterprise information system is available via HTTP.

12. The server of claim 1 1, wherein the HTTP connector comprises:
instructions to obtain an existing physical connection to an enterprise information system.

13. The server of claim 12, wherein the HTTP connector comprises:
instructions to return at least one connection handle corresponding to the existing physical connection to the connection manager.

14. The server of claim 11, wherein the HTTP connector comprises:
instructions to establish a new physical connection to the enterprise information system.

15. The server of claim 14, wherein the HTTP connector comprises:
instructions to return at least one connection handle corresponding to the new physical connection to the connection manager.

16. A method for obtaining an HTTP connection to an enterprise information system in a J2EE environment, the method comprising:
receiving a request for an HTTP connection to an enterprise information system;
detecting the availability of a physical connection to the enterprise information system via HTTP; and
transmitting at least one connection handle corresponding to the physical connection to the enterprise information system.

17. The method of claim 16, wherein the request for the HTTP connection is received at an HTTP connector residing in a web application server.

18. The method of claim 17, wherein the HTTP connector is J2EE compliant.

19. The method of claim 18, wherein the request for the HTTP connection is received at the J2EE HTTP connector from a connection manager residing in the web application server.

20. The method of claim 19, further comprising:
locating an existing physical connection to the enterprise information system.

21. The method of claim 20, further comprising:
returning at least one connection handle that corresponds to the existing physical connection to the enterprise information system.

22. The method of claim 19, further comprising:
establishing a new physical connection to the enterprise information system.

23. The method of claim 22, further comprising:
returning at least one connection handle that corresponds to the new physical connection to the enterprise information system.
